(19) United States
(12) Patent Application Publication
(10) Pub. No.: US 2007/0147642 A1
(43) Pub. Date: Jun. 28, 2007

(54) Method for constructing an otoplastic and calibrating a hearing device

(75) Inventor: Robert Kasanmascheff, Hochstadt (DE)

Correspondence Address: Siemens Corporation;Intellectual Property Department, 170 Wood Avenue South, Iselin, NJ, 08830, US

(73) Assignee: Siemens Audiologische Technik GmbH

(21) Appl. No.: 11/639,109

(22) Filed: Dec. 14, 2006

Related U.S. Application Data
(60) Provisional application No. 60/753,373, filed on Dec. 22, 2005.

(51) Int. Cl. H04R 25/00

(52) U.S. Cl. 381/322; 381/324

(57) ABSTRACT

Adjusting a hearing device and thus also shaping the otoplastic or hearing device shell are to be optimized. Provision is made for this purpose to firstly geometrically measure a portion of the auditory canal, to extrapolate the remaining portion of the auditory canal and to produce a geometric model of the auditory canal based thereupon. An acoustic model of the auditory canal can then be determined using the geometric model, with account being taken in the acoustic model of the shape of the otoplastic or the hearing device. Finally the otoplastic or hearing device shell can be designed with the help of the geometric and the acoustic model. The hearing device can likewise be calibrated with the help of the acoustic model, which comprises the optimized otoplastic or hearing device shell.

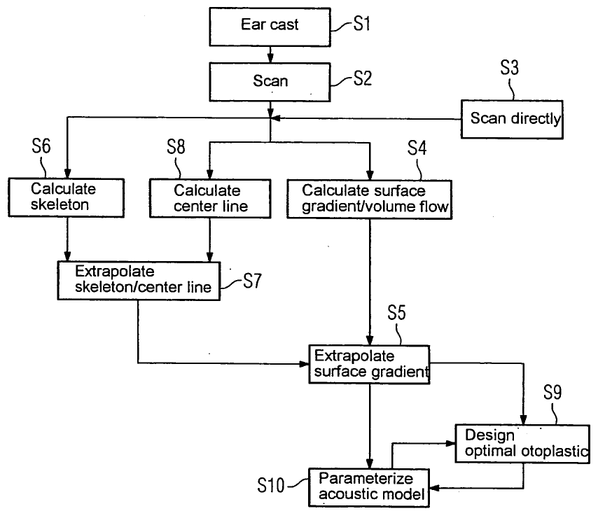

### CROSS REFERENCE TO RELATED APPLICATIONS

The present application claims the benefit of the provisional patent application filed on Dec. 22, 2005, and assigned application No. 60/753,373, which is incorporated by reference herein in its entirety.

### FIELD OF THE INVENTION

The present invention relates to a method for constructing an otoplastic or a hearing device shell, with one part of the auditory canal being geometrically measured. The present invention further relates to a method for calibrating a hearing device.

### BACKGROUND OF THE INVENTION

Every auditory canal has a certain characteristic acoustic quality. The acoustic quality changes if for example an otoplastic or an in-the-ear hearing device is inserted into the auditory canal.

Hearing devices must in turn be adjusted to the individual wearer. In particular, they must be calibrated depending on the individual auditory canal. To this end the acoustician can measure curves for example, such as the RECD (real ear to coupler difference), which can then be utilized to improve the adjustments made. If measurement methods are not available-for this purpose, the hearing devices are adjusted without more precise knowledge of the individual acoustic conditions.

Since the auditory canal and the inserted otoplastic or hearing device shell are in direct acoustic interaction, the individual acoustic conditions should also be utilized for the design of the hearing device shell or otoplastic. In practice each of the specific acoustic conditions are measured and fed into a simulation model. The design of the otoplastic or hearing device shell is only be influenced by empirical values. Design optimization, which has a direct influence on acoustic quality, is thus not possible. Due to the recursivity of this problem, the hearing device can only be calibrated in this way to a certain extent.

A method and a device for determining the acoustic parameters of a hearing device using a software model are known from the publication EP 0396 831 B1. In this publication, the user's target auditory acuity and the hearing device's transfer function are determined. The software model of the transfer function or of the transfer function of an exemplary model of the hearing device is stored.

The publication EP 1 251 716 B1 further discloses the modeling of converters in a digital hearing device. An electroacoustic model of a digital hearing device is accordingly developed using an energy gage as shown.

The publication EP 1 207 718 A2 further describes a method for adjusting a hearing device. A model for determining a psychoacoustic parameter, in particular loudness, is parameterized for a standard group of people. On account of differences between models, particularly with regard to their parameterization, position data is determined with which the signal transfer to a hearing device is designed or calibrated ex situ or conducted in situ.

### SUMMARY OF THE INVENTION

The object of the present invention consists in improving the construction process of an otoplastic or a hearing device shell and in connection thereto also to propose an optimized calibration method for hearing devices.

This object is achieved in accordance with the invention by a method for constructing an otoplastic or a hearing device shell by geometrically measuring one part of the auditory canal, extrapolating the geometry of the remaining part of the auditory canal, producing a geometric model from the measured and extrapolated geometry of the auditory canal, creating an acoustic model of the auditory canal using a geometric model and designing the otoplastic or the hearing device shell with the help of the geometric and acoustic model, the shape of the otoplastic or of the hearing device shell being taken into consideration in the acoustic model.

A method is further provided in accordance with the invention for calibrating a hearing device by geometrically measuring one part of the auditory canal, extrapolating the geometry of the remaining part of the auditory canal, producing a geometric model from the measured and extrapolated geometry of the auditory canal, creating an acoustic model of the auditory canal using a geometric model, parameterizing the acoustic model taking account of an otoplastic inserted into the auditory canal or a hearing device shell, and calibrating the hearing device using the parameterized acoustic model.

In accordance with the invention, the acoustic quality of the auditory canal is advantageously taken into consideration in the construction of an otoplastic or hearing device shell, and when calibrating a hearing device, account is also taken of the acoustic conditions of the auditory canal.

The above mentioned methods for calibrating a hearing device and for constructing an otoplastic or hearing device shell are preferably combined with one another. Here, the otoplastic or hearing device shell is designed with the help of the geometric and acoustic model, and the shape of the otoplastic or of the hearing device shell is taken into consideration in the acoustic model. Optimal construction of the otoplastic or hearing device shell as well as optimal calibration of the hearing device is thus achieved.

When measuring the geometry of the part of the auditory canal, a skeleton, centerline, surface gradient and/or volume flow of the auditory canal which are known from algorithmic geometry may be determined, and this data can then be used for the extrapolation. Algorithmic geometry methods can thus be advantageously employed for measuring the auditory canal.

Centerline is understood in the present document to mean a series of lines or a network of lines containing center properties relating to the skeleton. Calculating center lines does not necessarily require the calculation of a skeleton. A centerline is a subset of the points from a central axis. The central axis of a body (e.g. of the auditory canal) is described by the set of midpoints of all spheres that come into contact with the surface of the body at at least two points, but which do not intersect the surface.

In a special embodiment of the method according to the invention, measuring of the auditory canal can be performed through direct scanning. This is very expensive from a technical perspective, however it yields the best results in an ideal case. Furthermore no time-consuming interim steps are necessary.

Alternatively a cast of the ear can also be taken and scanned in order to measure the auditory canal. Such a measurement method can be realized comparatively easily.

In a further advantageous embodiment of the method according to the invention, extrapolation involves extrapolating the skeleton or the centerline of the remaining part of the auditory canal. The surface gradient of the auditory canal can then be extrapolated more easily from this data.

Parameterizing the acoustic model on the one hand, and designing the otoplastic or hearing device shell or calibrating the hearing device on the other hand, can be repeated alternately several times for optimization purposes. It is thus possible to achieve an optimal otoplastic and an optimal calibration of the hearing device very rapidly.

### BRIEF DESCRIPTION OF THE DRAWING

The present invention is now described in more detail below with reference to the appended drawing, which shows a flowchart for several alternative methods according to the invention.

### DETAILED DESCRIPTION OF THE INVENTION

The exemplary embodiments shown in more detail below represent preferred embodiments of the present inventions.

For optimal design of an otoplastic and for optimal calibration of the corresponding hearing device, a cast of the ear is first taken for one part of the auditory canal in a step S1 according to the figure. This cast of the ear is scanned in step S2 in order to capture its surface data. According to step S3, this surface data can also be gathered directly by scanning the ear or auditory canal. In any case the scanned data only relates to one part of the auditory canal. The aim now is to obtain data for the geometry of the entire auditory canal from this now known part of the auditory canal. In accordance with step S4, the surface gradient and volume flow for the known part of the auditory canal can be calculated directly from the scanned data, from which the surface gradient of the entire auditory canal can be extrapolated according to step S5. However extrapolation of the entire surface gradient (step S5) from the calculated surface data of the known part of the auditory canal is very compute-intensive.

Alternatively (in step S6) a so-called skeleton is computed from the scanned data of the known part of the auditory canal as per step S2. Skeleton is understood to mean a geometrical structure as is commonly used in algorithmic geometry. Skeletons can be determined for three-dimensional structures as well as for surfaces. However for the present application it is not absolutely necessary to compute the skeleton exactly; a similar geometrical structure can also be determined.

The skeleton of the remaining part of the auditory canal can be extrapolated without great overhead (step S7) from the skeleton data of the known part of the auditory canal. The surface gradient of the auditory canal can then be easily determined (step S5) from the skeleton of the entire auditory canal.

Instead of the skeleton, a centerline can also be calculated from the scanned data of the known part of the auditory canal in accordance with step S8. Like the skeleton, this centerline of the known part of the auditory canal can be easily extrapolated according to step S7. The surface gradient of the unknown part of the auditory canal is then extrapolated in step S5 from the extrapolated centerline. Optionally, extrapolation via the skeleton or the centerline is also possible with very little computing overhead. Direct extrapolation using the surface data requires rather more computing overhead, as has already been mentioned.

On the one hand, an otoplastic can be designed from the surface data in accordance with step S9, and on the other hand an acoustic model can be parameterized according to step S10. In the acoustic model account can also be taken of the inserted otoplastic, as symbolized by the arrow from step S9 to step S10 in the FIG. Conversely the acoustic model and the geometric model i.e. the surface data, allow the otoplastic or the hearing device shell to be optimized. This is indicated in the FIG by the arrow from step S10 to step S9. A loop is thus produced between steps S9 and steps S10, which can be run through repeatedly in order to optimize the acoustic model or the otoplastic. Finally an acoustically optimized otoplastic or hearing device shell and an individually optimized acoustic model, which can serve as the basis for calibrating the hearing device, are produced.

Due to the inventive extrapolation and the ensuing parameterization of the acoustic model or optimization of the otoplastic, the acoustician no longer has to perform extensive measurements in order to be able to perform a relatively precise adjustment.

The geometry of the hearing device shell or otoplastic can be further acoustically optimized. Finally it is easier to identify the reason for errors in the adjustment strategy because the simulated curves better reflect reality.

1. A method for constructing a hearing device shell to be worn by a wearer, comprising:
geometrically measuring a portion of an auditory canal of the wearer;
extrapolating a geometry of a remaining part of the auditory canal;
generating a geometric model of an entire auditory canal from the measured and the extrapolated geometry of the auditory canal;
creating an acoustic model of the auditory canal based on the geometric model; and
designing a shape of the hearing device shell according to the geometric model and the acoustic model, wherein the shape of the hearing device shell is included in the acoustic model.

2. The method as claimed in claim 1, wherein the acoustic model is updated by the shape of the hearing device shell and the designing of the shape of the hearing device shell is updated by the geometric model and the updated acoustic model.

3. The method as claimed in claim 1, wherein the geometric model of the entire auditory canal is a surface gradient of the entire auditory canal.

4. The method as claimed in claim 1, wherein a surface gradient or a volume flow of the measured portion of the auditory canal is determined from the measurement.

5. The method as claimed in claim 4, wherein a surface gradient of the remaining portion of the auditory canal is extrapolated based on the surface gradient or the volume flow determined from the measurement.

6. The method as claimed in claim 1, wherein a skeleton or a centerline of the measured portion of the auditory canal is determined from the measurement.

7. The method as claimed in claim 6, wherein a skeleton or a centerline of the remaining portion of the auditory canal is extrapolated based on the skeleton or the centerline determined from the measurement.

8. The method as claimed in claim 7, wherein the geometric model of the entire auditory canal is extrapolated based on the measured and extrapolated skeleton or the centerline.

9. The method as claimed in claim 1, wherein the auditory canal of the wearer is scanned directly for the measurement.

10. The method as claimed in claim 1, wherein a cast of an ear of the wearer is scanned for the measurement.

11. The method as claimed in claim 1, wherein the method is used for constructing an otoplastic.

12. A method for calibrating a hearing device to be worn by a wearer, comprising:
geometrically measuring a portion of an auditory canal of the wearer;
extrapolating a geometry of a remaining portion of the auditory canal;
generating a geometric model of an entire auditory canal from the measured and the extrapolated geometry of the auditory canal;
creating an acoustic model of the auditory canal based on the geometric model;
parameterizing the acoustic model comprising a shell shape of the hearing device inserted into the auditory canal; and
calibrating the hearing device using the parameterized acoustic model.

13. The method as claimed in claim 12, wherein the shell shape of the hearing device is designed based on the geometric model and the acoustic model

14. The method as claimed in claim 13, wherein the acoustic model is updated by the shell shape of the hearing device and the designing of the shell shape of the hearing device is updated by the geometric model and the updated acoustic model.

15. The method as claimed in claim 14, wherein the parameterization of the acoustic model and the designing of the shell shape of the hearing device are repeated alternately for an optimization.
